(19) United States
(12) Patent Application Publication
(10) Pub. No.: US 2006/0290134 A1
(43) Pub. Date: Dec. 28, 2006

(54) Project management organizer clip

(76) Inventors: Steven Patrick Pascale, Irvine, CA (US); Michael Patrick Pascale, San Clemente, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/178,217

(22) Filed: Jul. 8, 2005

Related U.S. Application Data
(60) Provisional application No. 60/690,294, filed on Jun. 14, 2005.

(51) Int. Cl. B42D 17/00

(52) U.S. Cl. 281/44

(57) ABSTRACT

An organizer clip may have a card and a clip on the card. For ease of handling and aesthetics, the card may be generally rectangular with concave sides and rounded corners. The card may be bisected by a perforation allowing separation of a lower portion for filing. The card may be laminated and features writing surfaces on its front and back surfaces. The clip may be formed on the card by a die cut shape creating upper and lower clip portions and a tongue. A gripping surface of a natural or synthetic rubber may be on the tongue enhancing the grip of the clip grips on a document. Two notepads may be disposed on the front of the card to provide writing and labeling surfaces. The notepads may be bound with pressure sensitive adhesive so that individual sheets of the note pads may be removed and adhered to another surface.

### CROSS-REFERENCE TO RELATED APPLICATIONS

This application claims the benefit of U.S. Provisional Patent Application Ser. No. 60/690,294, entitled “MEMO-CLIP” filed on Jun. 14, 2005.

Also, this application hereby incorporates by reference the above-identified provisional application in its entirety.

### BACKGROUND OF THE INVENTION

1. Field of the Invention

The invention relates generally to the field of office supplies, more specifically, the invention relates to devices to organize pertinent information.

2. Description of the Related Art

In the modern team-oriented workplace, collaboration, coordination, and communication among members of a team are essential for effective delivery of quality products and services. But previous attempts at creating a clip based organizer to provide some of the required functionality have fallen far short of delivering the collaboration, coordination, and communication functionality necessary to enhance delivery of products and services.

Across almost all industries, productive collaboration among members of a team is essential to ensure quality products or services are delivered to a customer's satisfaction. For example, collaborative efforts are required for activities such as product development, promotions, licensing, production, patient care, flight clearances, purchasing, finances and budget, HR, scheduling and various services. To effectively oversee a collaborative team effort, managers alike must be concerned about a number of variables, and collaboration among team members is necessary to achieve a most effective utilization of resources.

Similarly, to ensure quality products and services are delivered, a manager is charged with coordinating team members and work tasks. Such coordination is typically directed towards ensuring that activities are carried out in relation to their importance and with a minimum of conflict.

Communications in the workplace among team members or workers and supervisors is vital to the success of any project. Effective communications minimize ambiguity and perception differences. Alternatively, miscommunications can lead to poor decisions and poor quality products.

When handling documents in a work environment, paper clips, binder clips, tape flags, and self adhesive notes have been used to facilitate communications among team members. However, these devices are quite limited in their ability to facilitate coordination, communications, and collaboration among team members as they provide, at best, small writing surfaces and typically have no mechanism for leaving a lasting record to later team members.

### SUMMARY OF THE INVENTION

In light of the shortcomings of the noted above, there is a need for an organizational device that is capable of gripping and retaining one or more sheets of paper and that provides enhanced organizational functionality. Additionally, there is a need for a clip-based organizational device that facilitates collaboration, coordination, and communication among members of a team.

In contrast to the limited organizational functionality of the prior art, one aspect of embodiments of the present invention is to provide organizational devices which are capable of gripping and retaining one or more sheets of paper, and provide enhanced organizational functionality to facilitate collaboration, coordination, and communication among team members. These organizational devices clip to the sides of a sheet or sheets of paper, folders, documents or reports. These organizational devices have broad applicability and can be used across many industries. For example, they can be used for quality control tagging functions within the manufacturing process, retail promotions, software licensing, movie making dailies, or air traffic control pilot clearances. The advantages realized by the various embodiments of the present invention provide time-saving value by any definition.

Another aspect of the organizer devices is that they assist people in overcoming the limited functionality that exists with regards to conventional organizers and self-adhesive notes. A purpose of the organizer devices of the present invention is to provide an organizer device having enhanced features such as index filing card functionality, writing surfaces, indicia marking surfaces, and enhanced gripping capabilities.

Embodiments include a clip-based organizer device capable of attaching to single and/or multiple layers of paper, card stock type materials, and other working elements that can be clipped or flagged. A clip based organizer of the present invention may effectively be used to optimize A) administrative and strategic functions (examples: quality/customer satisfaction); B) team work and systemized concurrence; and C) Exchange of information, messages, or directives informatively.

In certain embodiments, an organizer device is capable of gripping and retaining one or more sheets of paper and provides enhanced functionality to facilitate collaboration, coordination and communication among team members. The organizer device comprises a card having a quasi-rectangular ergonomic shape formed from a firm card stock, a clip formed on the card and configured to retain at least one sheet of paper, a primary notepad removably affixed to a front surface of the card, a secondary notepad removably affixed to a front surface of the card a first flag rotatably mounted to a front surface of the card, and a second flag rotatably mounted to a back surface of the card. The card has a substantially linear perforation allowing one section of the card to be removable from a remaining section of the card. The clip includes a lower clip portion, an upper clip portion, a tongue portion, a plurality of perforated sections disposed on a central area of the tongue portion, and a rubber shim having a plurality of raised bumps disposed on a lower edge of the tongue portion. The primary notepad comprises a plurality of sheets of paper, and the secondary notepad comprising a plurality of sheets of paper.

In certain other embodiments, an organizer device comprises a card having a front surface and a back surface and a clip formed on the card and configured to retain at least one sheet of paper. The card may be comprised of card stock weight paper that has been cut to a desired shape. The card may be laminated on at least one surface for additional durability and to provide a reusable writing surface. The card has a multitude of areas where distinguishable indicia may be disposed. The clip further comprises a lower clip portion, an upper clip portion, a tongue section, and at least one gripping surface disposed on the tongue section. The clip is configured to attach single and/or multiple layers of paper, card paper stock type materials and other working elements that can be clipped or tagged. Given the versatility of the clip, the organizational device can be placed in various designated locations (top, bottom, left, or right edges of documents/reports) highlighting important areas of the attached sheet or sheets. The gripping surface of the clip may be comprised of a natural rubber or synthetic rubber shim. To enhance friction between the gripping surface and an attached document, the gripping surface may be textured with features such as raised circular bumps. To further enhance stability on a gripped document, the card may feature a pressure adhesive strip on the back surface of the card.

In certain other embodiments, an organizer device comprises a card having a front surface and a back surface and a clip disposed on the card and configured to retain at least one sheet of paper. The card comprises an upper portion, a lower portion, and a perforation between the upper portion and the lower portion such that the lower portion is separably attached to the upper portion. The lower portion may additionally feature removable punch out sections to facilitate filing-card-like indexing or detachable receipt functionality for the removable lower portion of the card.

In yet other embodiments, an organizer device comprises a card having a front surface and a back surface, a clip disposed on the card and configured to retain at least one sheet of paper, a primary notepad removably adhered to the front surface of the card, and a secondary notepad removably adhered to the front surface of the card. The primary and secondary notepads may have pressure sensitive adhesive areas. The pads themselves are for writing notes. Furthermore, these notes can be strategically removed and placed on secondary documents where warranted. The two notepads can be replaced as desired. Additional writing surfaces are provided by the front and back surfaces of the card, which may be laminated in order to facilitate a rewritable surface if washable ink markers are used.

In other embodiments, methods of making an organizer device having a card and a clip formed on the card are disclosed. The methods include providing paper for at least one card, cutting the card with a laser die to form a clip having a tongue and a cut window, and cutting the card from the paper. Laser die cutting allows the clip to be cut with precise tolerances, thereby facilitating the production of a clip which may be used to retain a standard-sized (2″ width) business card or other documents of known dimensions.

In still other embodiments, methods of using an organizer device are disclosed. The organizer device includes a card having a quasi-rectangular ergonomic shape formed from a firm card stock and a clip formed on the card and configured to retain at least one sheet of paper, the clip comprising a lower clip portion. The card has a substantially linear perforation, allowing one section of the card to be removable from a remaining section of the card. The clip includes an upper clip portion, a tongue portion, a plurality of perforated sections disposed on a central area of the tongue portion, and a gripping surface disposed on a lower edge of the tongue portion. The methods of using the organizer device include inserting at least one sheet of paper into the clip such that the gripping surface of the clip retains the sheet of paper; and marking status information about the at least one sheet of paper on the card.

Embodiments of the organizer device advantageously serve as organizers with enhanced administrative functions such as an information transport, index file card, business card holder, project status display, and note or memo writing surface. Thus, the organizer device apparatus may provide the ability to write notes, place value or importance levels regarding those notes or the retained documents and confer an added level of utility to project document organization and/or administration.

According to various embodiments, the organizer device may be constructed to various desired shapes and sizes corresponding to various intended uses. The organizer device may provide various features to enhance the coordination, communication, and collaboration supported by the device. For example, project headers specifying specific types of functional areas may be present on the card of the organizational device. Moreover, the organizer device may also comprise perforated boxes indicating level of importance (for example on a 1-5 scale) and the percentage complete (0%-25%-50%-75%-100%) on a project or rotatable flags to signal a particular decision has been made to future users of a document.

For purposes of summarizing the invention and the advantages achieved over the prior art, certain aspects and advantages of the invention have been described above and as further described below. Of course, it is to be understood that not necessarily all such aspects or advantages may be achieved in accordance with any particular embodiment of the invention. Thus, for example, those skilled in the art will recognize that certain embodiments may achieve or optimize one advantage or group of advantages as taught herein without necessarily achieving other aspects or advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment(s) disclosed

### BRIEF DESCRIPTION OF THE DRAWINGS

FIG. 1 is a front view of an organizer device according to an embodiment of the present invention;

FIG. 2 is a rear view of the organizer device of FIG. 1;

FIG. 3 is an expanded rear view of a primary notepad according to certain embodiments of the present invention;

FIG. 4 is an expanded rear view of a secondary notepad according to certain embodiments of the present invention;

FIG. 5 is a perspective view depicting a preferred embodiment of the organizer device as applied to an article.

FIG. 6 is a perspective view depicting a preferred embodiment of the organizer device as applied to an article.

### DETAILED DESCRIPTION OF THE PREFERRED EMBODIMENT

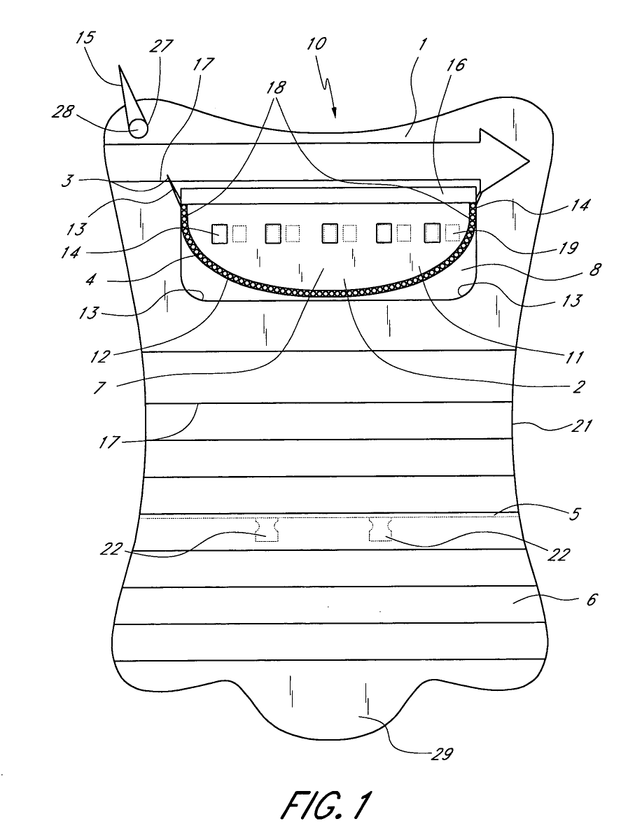

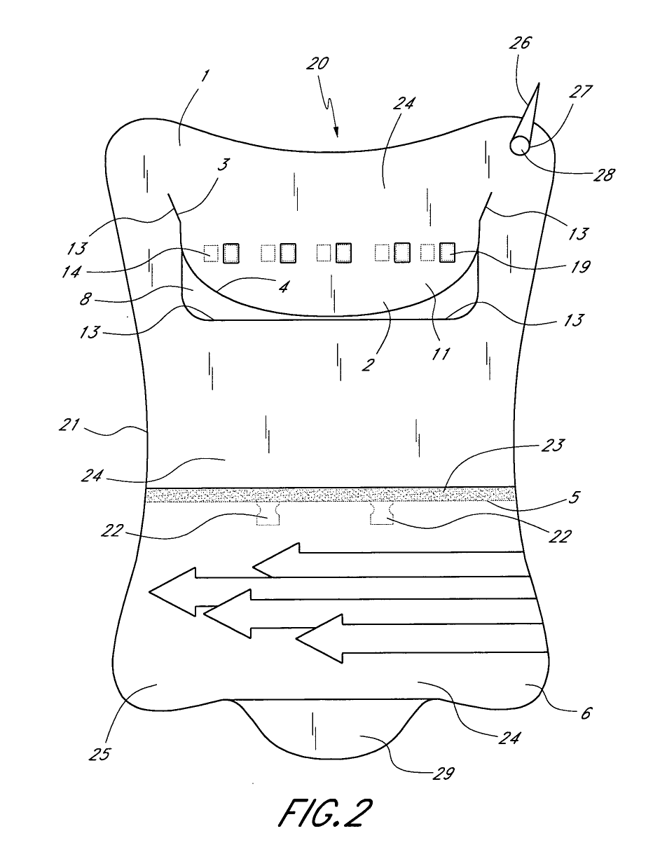

Specifically, with respect to FIGS. 1 and 2, an organizer device of the present invention is depicted. FIG. 1 depicts a front view of an embodiment of the organizer device, and FIG. 2 depicts a rear view of the organizer device of FIG. 1. As depicted in FIG. 1, the organizer device comprises: a card 1 having a front surface 10 and a clip 2 comprising a tongue portion 11 and a gripping surface 12. The user environment may define how the organizer device helps organize various project functions in a way that makes sense for a user of the organizer device. Thus, the integration of various combinations of different features, as described in greater detail below, in an organizer device will form various embodiments of an organizer device according to the present invention.

The Card of the Organizer Device

The card 1 may be comprised of a firm card stock or other pliable material. Preferably, the card 1 is comprised of card stock having a weight ranging from 0.8 to 0.20. The card 1 may be laminated on at least one surface for additional durability and to provide a reusable writing surface. For example, either or both of the front surface 10 and the back surface 20 (FIG. 2) of the card 1 may be laminated to provide a reusable writing surface when written on with washable ink markers. Preferably, the laminate is between approximately 0.1 and 0.9 clear mil thick, although other thicknesses are contemplated and are within the scope of the present invention.

In one preferred embodiment, the card 1 of the organizer device is perforated horizontally at approximately its mid-section, allowing a lower portion 6 of the card 1 to be removed from a top portion. There is a perforation 5 disposed horizontally across the card 1 of the organizer device that allows the lower portion 6 to be removed. In certain embodiments, the lower portion 6 also includes at least one knock-out tab 22 that allows the removable lower portion 6 of the organizer device to be inserted into a card indexing file. Advantageously, this card indexing feature may facilitate communication and collaboration of group members as subsequent users of a document can rapidly locate indexed information pertaining to a document.

In certain embodiments, and as depicted in FIGS. 1 and 2, the card 1 of the organizer device is a quasi-rectangular ergonomic shape. The shape features concave edges 21 (for human factors) along its four outer sides, giving it a lobed appearance. A fifth lobe 29 may be disposed at the center of the bottom side, and may be used as a handle for raising, lowering or removing the organizer device. This lobed shape creates an organizer device that is both aesthetically pleasing and ergonomic. While the particular lobed shape illustrated is believed to have certain ergonomic benefits, other shapes may be used which possess similar ergonomic benefits.

The organizer device card 1, along with the clip 2 and perforations 5, 22 are preferably cut via a laser die-cut and or other similar means in order to produce clean, sharp and durable edges. In another embodiment, the organizer device has an overall card tear-out perforation cut, allowing the organizer device to be vended in sheets that may be fed through a home or office printer; thus, allowing the ability to personalize the contents or theme of the organizer device, or to produce organizer device cards 1 in a series where necessary. Advantageously, this printable configuration allows the organizer device of the present invention to be adaptable to a wide variety of uses such that the collaborative benefits offered by various embodiments of the organizer device may have wide applicability.

The fifth lobe 29 provides a front side (shown in FIG. 1) and a back side (shown in FIG. 2) for disposing marking indicia. For example, the front side or the back side of the fifth lobe 29 may be marked with (adhesive peel-off) stickers or printed letters (raised by melting plastic particles through a process known in the art such as thernography). The marking indicia can be used to identify one indexed lower portion 6 of an organizer device card 1 out of a group by observing the marking indicia such as color or alpha-numeric designation on the lobe. The curvature of the fifth lobe 29 design may permit the labeling section of the organizer device to sit above a page allowing an intended recipient user to grasp the organizer device from the top when clipped to papers.

Although uniform in shape, the organizer device card 1 may come in a range of sizes, from preferably approximately 1.9 inches by 2.3 inches to approximately 3.5 inches by 4.75 inches. Desirably, the organizer device card 1 has a dimension ranging from approximately 1.5 inches to 11 inches. Although these sizes are demonstrative examples, other sizes may be included as necessary depending on the field of application of the organizer device.

In one preferred embodiment, a small generally triangular flag 15 is disposed on an upper corner of the card 1 of the organizer device through the utilization of a grommet 28 or other fastener. The grommet 28 or other fastener may be inserted into a cut aperture 27 in the card 1, such as a die cut aperture. The flag 15 is rotatable in the plane of the organizer device card 1 as an additional communication vehicle for denoting project progress and/or attention needed. For example, the flag 15 may be used to indicate whether or not to proceed with a particular task—a so-called go-no go decision. In certain embodiments, the flag 15 may be color coded. For example, the flag 15 may be green to indicate a decision to proceed has been made on an attached memo or other document. In certain embodiments, the flag 15 may be laminated. Advantageously, the flag 15 allows one viewer of an article to communicate with subsequent users of a document such as to indicate that a particular article is of interest or that a decision has been reached regarding a particular article.

The Clip of the Organizer Device

The clip 2 may retain an edge of a sheet or sheets of paper, a folder, report, document, manual or other similar surface. A sheet or sheets of paper, a folder, report, document, manual or other similar surface are collectively referred to herein as an article. As depicted, the clip 2 is formed on the card 1 by a cut shape 13 of the clip 2 defining an upper clip portion 3, a lower clip portion 4, and a tongue section 11. The cut shape 13 may be formed by die cutting. Preferably, the cut shape 13 is formed by laser die cutting. Advantageously, laser die cutting allows precise tolerances to be met such that the clip 2 may be configured to retain specific document sizes. In certain embodiments, a cut shape 13 formed as a die cut window is horizontally centered in the top half of the organizer device card 1. The cut shape 13 has two sides and a bottom consisting of generally straight cuts with rounded edges connecting them. The tongue section 11 extends towards the bottom of the cut shape 13. As depicted, there is an aperture 8 of removed card material between an edge of the tongue section 11 and the cut shape 13. As discussed in further detail below, the sides of the cut shape 13 are configured to create an upper clip portion 3 and a lower clip portion 4 such that the cut shape 13 is configured to grip an edge of an attached article (at the junction of the tongue section 11 and the upper ends of the cut shape 13). The upper and lower clip portions 3, 4 and the configuration of the cut shape 13, with two side cuts extending slightly upward and outward near their upper ends serves to increase the gripping strength of the tongue section 11 and clip 2 when the organizer device grips an article. Advantageously, the high gripping ability of the organizer devices enhance collaboration and communication among team members as, unlike self-adhesive notes, the organizer devices are not likely to become separated from their attached articles.

In certain embodiments, the overall width of the cut shape 13 is approximately 1.988 inches wide to create a tension fit with standard size business cards, which have a width of 2 inches in portrait orientation (2 inch height if in landscape orientation). In this manner, the cut shape 13 of the clip 2 also serves as a business card holder 18, allowing one or more business cards to be retained in the clip 2 of the organizer device while it adheres to an article. This business card retaining feature allows the organizer device to enhance communications among team members as contact information such as that for a user with primary responsibility for an article can be retained with the article.

The lower clip portion 4 has a downward facing mouth opening to an inner surface, which is shaped to accept an article such as a document, report, folders or board like instrument (including manuals) front vertical edge by applying the clip downward onto the article thereby pushing a mouth of the clip 2 apart to accept the article. The upper clip portion 3 has an upward facing mouth opening to an inner surface, which is shaped to accept separate cylindrical articles of differing diameter.

When applying the organizer device to an article, first, the lower clip portion 4 is placed on the article by pushing the article into the clip 2 thereby urging the tongue section 11 apart from the card 1 such that the clip 2 accepts and holds the article in place. Then, the article is advanced further into the clip 2 such that the upper clip portion 3 of the organizer device is pushed apart to accept and hold the article in place.

The gripping surface 12 may be comprised of a material such as a natural or synthetic rubber that provides enhanced gripping ability. Preferably, the gripping surface 12 comprises a shim disposed on a lower edge of the tongue section 11 to serve as a tacky surface to enhance grip on a gripped article. The gripping surface 12 may also comprise a horizontal shim 16 extending generally horizontally across an upper edge of the tongue section 11. The gripping surface 12 may feature a variegated surface, with small raised areas for instance, to help the gripping surface 12 grip various types of surfaces. Advantageously, the gripping surface 12 increases the tensile strength of the tongue section 11 when in contact with papers or documents held by the clip 2. Additionally, when variegated, the gripping surface 12 provides an improved finger gripping texture for the organizer device.

In certain embodiments, a front side of the tongue section 11 contains perforated sections 14 to indicate the degree of completion of a task, or other indicia that can be indicated with a small mark and/or by punching out a section along the perforations. Although they are depicted as perforated substantially square boxes, the perforated sections 14 may take on any desired shape such as, for example, perforated substantially circular segments.

In certain embodiments, an embossed area 7 is disposed on the front side of the tongue section 11 below the perforated sections 14. The embossed area 7 may be used to present a customizable logo or other personalized information. For example, a business trade name or other advertising indicia can be embossed in the embossed area 7.

Writing and Indicia Surfaces Provided by the Organizer Device

Below the clip 2, the face of the card 1 may contain a writing surface 17 having lines, wherein remarks may be recorded regarding the subject matter. Alternately, the writing surface 17 may be unlined. In certain embodiments, the front surface 10 of the card 1 is laminated thereby providing a reusable writing surface for use with washable ink markers on the front surface 10 of the card 1 below the clip 2. This rewritability allows multiple viewers of an article to effectively communicate their notes and comments in a conversational back-and-forth manner, thus enchancing collaboration among team members.

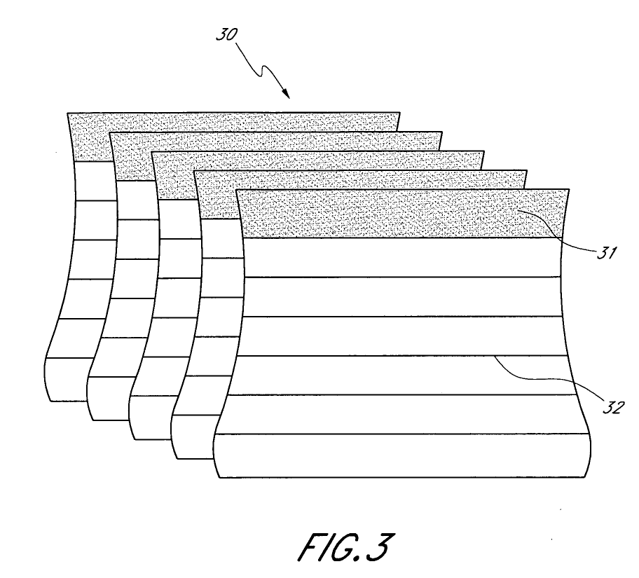

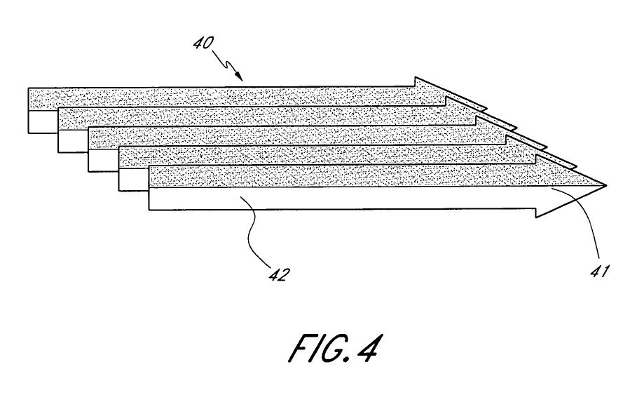

As described in further detail below with respect to FIGS. 3 and 4, in one preferred embodiment, a primary notepad 30 (FIG. 3) of approximately five to fifteen sheets is disposed over the front surface 10 of the clip 1 generally over the writing surface 17. A secondary notepad (FIG. 4) of approximately five to fifteen sheets is disposed over the front surface 10 of the clip 1 generally upward of the tongue 11 of the clip 2. Advantageously, these notepads provide ample, and replenishible writing surface area for notes, memos, and labels. Also, these notepads enhance project communications, coordination, and collaboration, as team members are able to provide notes and comments regarding sections of a particular article that will be viewed by other members of the team.

When the organizer device is used to retain an article, the topmost portion of the card 1 above the clip 2 extends above the page or pages gripped by the organizer device. This topmost portion may provide visual cues such as color coding to increase the visibility of the organizer device, thus facilitating the use of multiple color-coded organizer devices in certain contexts.

Additionally, in one preferred embodiment, upper and lower portions of the card 1 can be UV coated to increase visibility.

The Back Surface of the Card

FIG. 2 depicts a rear view of the organizer device of FIG. 1. The card 1 comprises a back surface 20. As described in more detail with respect to FIG. 1, the clip 2, formed in the card 1 by a cut shape 13 that defines an upper clip portion 3 and a lower clip portion 4 is visible on the back surface 20 of the card.

Preferably, the entire back surface 20 of the card 1 is laminated with a clear lamination 25 of approximately 0.1 mil to 0.20 mil. The lamination adds strength and durability to the organizer device.

On the back surface 20 of the card 1, the area corresponding with the writing surface 17 of the front surface 10 may contain a blank space 24 for advertising and/or company specific information. The blank space 24 can also be used as a lineless writing area. Alternately, in embodiments where the back surface 20 is laminated, the blank space 24 may serve as a reusable writing surface for use with washable ink markers. The blank space 24 of the back surface 20 may also be used to store confidential information. When the organizer device is disposed with the front surface 10 in front of and the tongue section 11 behind the article retained by the clip 2, the writing surface 17 of the front surface 10 is visible. But, the blank space 24 on the back surface 20 faces inward and is obscured by the attached article to keep sensitive information confidential.

The back surface 20 of the card 1 may also contain a lined writing area on a lower portion 6 of the card 1 for use as an indexing card. For example, the fifth lobe 29 may be marked to indicate that the removable lower portion 6 of the card is to be completed with to/from at information and/or other information based on the intended application of the organizer device.

The topmost area of the back surface 20 of the card 1 may be used as a space for marked indicia or color coding similar to the corresponding area on the front surface 10 of the card 1.

The back side of the tongue section 11, likewise, may contain perforated sections 19 (similar to those described above with respect to the front surface 10 in FIG. 1) and a small area where indicia can be marked. In this manner, the organizer device is designed so that it may be disposed forward or backward on a sheet or sheets of paper or other similar materials.

The back surface 20 of the card 1 may also comprise a back flag 26 that is rotatable in the axis of the card about a grommet 28 or other fastener disposed in an aperture 27 cut in the card. The back flag 26 may be used similarly to the front flag 15 to indicate information or decisions. The back flag 26 and the front flag 15 may be color coded to indicate a specific decision to be made. For example, the front flag 15 may be green to indicate a “go” and the back flag 26 may be red to indicate a “no go.” These flags 15, 26 enhance communication and coordination among team members such as where, for example, a second viewer of an article knows not to perform redundant work because a decision has already been reached with respect to the document.

As an added measure of attachment, the organizer device may comprise a bead of pressure sensitive adhesive 23 backing on the back surface 20 of the card 1. The pressure sensitive adhesive 23 bead is preferably disposed just above the perforation 5 allowing separation of the lower portion 6 of the card 1. The pressure sensitive adhesive 23 serves as an anchor in conjunction with the organizer device to keep the card 1 and clip 2 in place on an article. Additionally, the back surface 20 of the card 1 may have a clear peel-off strip disposed over the pressure sensitive adhesive 23 strip until the pressure sensitive adhesive 23 strip is ready for use. Preferably, the pressure sensitive adhesive 23 strip is approximately ¼ inch wide and extends the width of the card 1. Advantageously, this adhesive strip 23 enhances communication by preventing the card 1 from becoming separated from the attached article.

The Primary Notepad of the Organizer Device

FIG. 3 depicts an expanded view of a primary notepad for use in certain embodiments of an organizer device of the present invention. Preferably, the primary notepad 30 comprises approximately five to fifteen sheets of paper removably bound by a bead of pressure sensitive adhesive 31 running along their top back edges. FIG. 3 depicts a rear view of several sheets of the primary notepad 30 separated from each other to show their pressure sensitive adhesive 31 beads. Thus, the primary notepad 30 provides self adhesive notes which may be removed from the primary notepad 30, and adhered to an article being retained by the organizer device or another surface. Preferably, the size and shape of the primary notepad 30 has the same general dimensions and contours as a portion of the card 1 of the organizer device such that the primary notepad 30 may be disposed over the writing surface 17 of the front surface 10 of the card 1. However, it is recognized that other configurations of the primary notepad may offer the same writing surface and ergonomic functionality. The fifth lobe 29 descends below the lowest extreme of the primary notepad 30, to facilitate pad removal from the clip. Advantageously, if a user exhausts all of the sheets of the primary notepad 30, a replacement primary notepad may be adhered to the card 1 quickly and easily. Therefore, the writing surface provided by the organizer device is virtually limitless, allowing comprehensive note taking and memo writing. In certain embodiments, the primary notepad 30 is lined with a plurality of generally horizontal lines 32 to ease note taking. Advantageously, the primary notepad enhances collaboration and communication by enabling viewers of an article to place written comments within the article at selected areas.

The Secondary Notepad of the Organizer Device

FIG. 4 depicts an expanded view of a secondary notepad for use in an organizer device of the present invention. Preferably, the secondary notepad 40 comprises approximately five to fifteen sheets of paper removably bound by a bead of pressure sensitive adhesive 41 running along their top back edges. FIG. 4 depicts a rear view of several sheets of the secondary notepad 40 separated from each other to show their pressure sensitive adhesive 41 beads. Thus, the primary notepad 40 provides self adhesive notes which may be removed from the secondary notepad 40, and adhered to an article being retained by the organizer device or another surface. The secondary notepad 40 is desirably smaller in size than the primary notepad 30 (FIG. 3) such that the sheets of the secondary notepad 40 are used for labeling or highlighting areas of importance rather than comprehensive note taking or memo writing. Preferably, the secondary notepad 40 is sized and configured to be adhered to the front surface 10 of the card 1 just above the clip 2. The secondary notepad 40 may be shaped to allow facilitate its intended use as a highlighting tool. For example, as depicted in FIG. 4, the secondary notepad 40 may be in an arrow shape to direct a viewer's attention to a selected item when a sheet of the secondary notepad 40 is used. However, other shapes of the secondary notepad 40, including other shapes designed to direct a viewer's attention, are also possible. In certain embodiments, the secondary notepad 40 is lined with at least one generally horizontal line 42 to ease writing thereon. Advantageously, the secondary notepad enhances collaboration and communication by enabling viewers of an article to place small notes within the article at selected areas.

Application of an Organizer Device to an Article

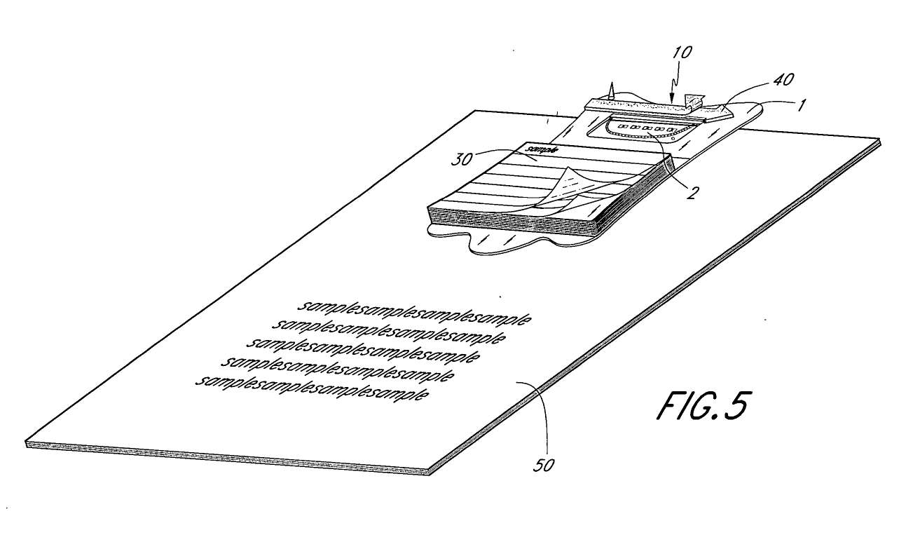

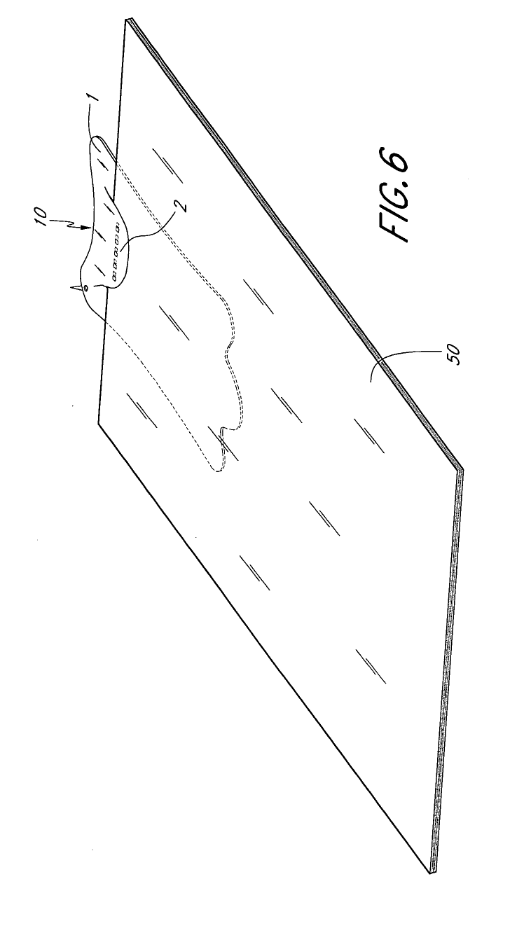

FIGS. 5 and 6 illustrate a preferred embodiment of the organizer device of the present invention as applied to an article 50. As depicted, the card 1 of the organizer is retaining at least one sheet of paper such as a document, folder, report, or manual, comprising an article 50. The organizer device comprises a card 1 having a clip 2 formed on a section of the card 1, a primary notepad 30 disposed on the card, and a secondary notepad 40 disposed on the card. The card 1 and clip 2 are as described above in connection with FIGS. 1 and 2, and the primary and secondary notepads 30, 40 are as described above with respect to FIGS. 3 and 4.

Method of Making an Organizer Device

A method of making an organizer device having a card and a clip formed from the card is also within the scope of the present invention. Generally, the method comprises the steps of providing paper for at least one card, cutting the card with a laser die to form a clip having a tongue and a cut window, and cutting the card from the paper. Additional steps may be implemented in the method, such as providing ink for at least one card and printing a predetermined pattern on the at least one card. Alternately additional steps may be provided to enhance the gripping ability of the card, such as applying an adhesive strip to a back surface of the at least one card or adhering a gripping surface to the tongue of the clip. Alternately, additional steps may be added that enhance writing and information providing surfaces of the card such as embossing predetermined text on the card, laminating at least one surface of the card, and attaching at least one flag to the card.

The card of the organizer device, along with the clip and perforations is achieved through laser die cutting or other similar techniques in order to produce clean, sharp and durable edges. In another embodiment, the organizer device may be made with an overall card tear-out perforation cut, allowing the organizer device to be vended in sheets that may be fed through a home or office printer; thus, allowing the ability to personalize the contents or theme of the organizer device, or to produce organizer devices in a series where necessary

Method of Using an Organizer Device

A method of using an organizer device having a card and a clip formed from the card is also within the scope of the present invention. The method of using an organizer device comprises the steps of inserting an article into the clip and marking status information about the article on the organizer device. The marking step may be accomplished by any of a number of ways, as enabled by the features of the organizer device. For example, the marking may be a mark in a perforated section on the tongue of the clip, a punch-out of the perforated section, a written comment on a surface of the card, a written comment on a primary notepad, a written comment on a secondary notepad, or rotating a flag. The method of using an organizer device may also include removing a portion of the card along a perforation in the card and storing it in a card file. Advantageously, as further described above with respect to components of various embodiments of organizer device, the method of using the organizer device enhances communication, collaboration, and coordination among members of a team.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. Further, the various features of this invention can be used alone, or in combination with other features of this invention other than as expressly described above. Thus, it is intended that the scope of the present invention herein disclosed should not be limited by the particular disclosed embodiments described above, but should be determined only by a fair reading of the claims that follow.

What is claimed is:

1. An organizer device capable of gripping and retaining one or more sheets of paper and providing enhanced functionality to facilitate collaboration, coordination and communication among team members, said device comprising:
a card having a quasi-rectangular ergonomic shape formed from a firm card stock, said card having a substantially linear perforation allowing one section of the card to be removable from a remaining section of the card;
a clip formed on the card and configured to retain at least one sheet of paper, the clip comprising a lower clip portion, an upper clip portion, a tongue portion, a plurality of perforated sections disposed on a central area of the tongue portion, and a rubber shim having a plurality of raised bumps disposed on a lower edge of the tongue portion;
a primary notepad removably affixed to a front surface of the card, the primary notepad comprising a plurality of sheets of paper;
a secondary notepad removably affixed to a front surface of the card, the secondary notepad comprising a plurality of sheets of paper;
a first flag rotatably mounted to a front surface of the card; and
a second flag rotatably mounted to a back surface of the card.

2. The organizer device of claim 1, wherein the plurality of sheets of paper comprising the primary notepad are bound with a pressure-sensitive adhesive and the plurality of sheets of paper comprising the secondary notepad are bound with a pressure-sensitive adhesive.

3. The organizer device of claim 1, wherein the clip is configured to retain a business card of a predetermined size.

4. The organizer device of claim 1, wherein the card further comprises a first writing surface formed by a front laminate layer disposed on a front surface of the card and a second writing surface formed by a back laminate layer disposed on a back surface of the card.

5. An organizer device comprising:
a card having a front surface and a back surface; and
a clip formed on the card and configured to retain at least one sheet of paper, the clip comprising:
a lower clip portion;
an upper clip portion;
a tongue section; and
at least one gripping surface disposed on the tongue section.

6. The organizer device of claim 5, wherein the tongue section further comprises at least one removable perforated section.

7. The organizer device of claim 6, wherein the at least one removable perforated section comprises at least one perforated box.

8. The organizer device of claim 5, wherein the gripping surface comprises a natural rubber shim.

9. The organizer device of claim 5, wherein the gripping surface comprises a synthetic rubber shim.

10. The organizer device of claim 5, wherein the gripping surface comprises a plurality of raised bumps.

11. The organizer device of claim 5, wherein the clip further comprises a cut shape having two side edges and a bottom edge; wherein the side edges define the upper clip portion and the lower clip portion; and wherein the tongue section extends towards the bottom edge of the cut shape.

12. The organizer device of claim 11, wherein the cut shape is configured such that the clip is configured to retain a business card.

13. The organizer device of claim 12, wherein a distance between the two side edges of the cut shape is approximately 1.988 inches to retain a business card having a width dimension of 2 inches.

14. The organizer device of claim 5, further comprising a primary notepad removably affixed to the front surface of the card.

15. The organizer device of claim 14, wherein the primary notepad comprises a notepad configured to overlie the card, the notepad comprising a plurality of sheets of paper removably bound with pressure sensitive adhesive, and wherein the primary notepad is removably affixed to the front surface of the card with pressure sensitive adhesive.

16. The organizer device of claim 14, further comprising a secondary notepad removably affixed to the front surface of the card.

17. The organizer device of claim 5, further comprising an adhesive strip disposed on the back surface of the card.

18. The organizer device of claim 17, further comprising a removable paper strip covering the adhesive strip.

19. The organizer device of claim 5, wherein the card is comprised of a card stock paper having a weight of between approximately 0.8 lbs and approximately 0.20 lbs.

20. The organizer device of claim 19, wherein a surface of the card is laminated.

21. The organizer device of claim 5, further comprising a flag rotatably connected to the card.

22. The organizer device of claim 5, further comprising a first flag rotatably coupled to the front surface of the card and a second flag rotatably coupled to the back surface of the card, wherein the first flag and the second flag are configured to be visually distinguishable.

23. An organizer device comprising:
a card having a front surface and a back surface; and
a clip disposed on the card and configured to retain at least one sheet of paper,
wherein the card comprises an upper portion, a lower portion, and a perforation between the upper portion and the lower portion such that the lower portion is separably attached to the upper portion.

24. The organizer device of claim 23, wherein the lower portion of the card comprises at least one perforated punch-out such that the at least one punch-out is separably attached to the lower portion.

25. The organizer device of claim 23, wherein the card has a quasi-rectangular shape comprising four sides, each of the four sides having a generally concave outer edge such that the card may be easily grasped by a user, and wherein the shape of the card further comprises a lobe disposed near a midpoint of one of the four sides of the card.

26. The organizer device of claim 25, wherein the lobe is disposed on the lower card portion, and wherein the lobe comprises an indexing feature.

27. The organizer device of claim 23, wherein the clip is formed of the card and wherein the clip further comprises:
a lower clip portion;
an upper clip portion;
a tongue section;
at least one gripping surface disposed on the tongue section;
and a cut shape having two side edges and a bottom edge; wherein the tongue section extends towards the bottom edge of the window.

28. An organizer device comprising:
a card having a front surface and a back surface;
a clip disposed on the card and configured to retain at least one sheet of paper;
a primary notepad removably adhered to the front surface of the card; and
a secondary notepad removably adhered to the front surface of the card.

29. The organizer device of claim 28, wherein the primary notepad comprises a notepad configured to overlie the card, the notepad comprising a plurality of sheets of paper removably bound with pressure sensitive adhesive, and wherein the primary notepad is removably adhered to the front surface of the card with pressure sensitive adhesive.

30. The organizer device of claim 28, wherein the secondary notepad comprises a notepad configured to be adhered to the front surface of the card, the notepad comprising a plurality of sheets of paper removably bound with pressure sensitive adhesive, and wherein the primary notepad is removably adhered to the front surface of the card with pressure sensitive adhesive.

31. The organizer device of claim 29, wherein the primary notepad comprises from 5 to 15 sheets of paper.

32. The organizer device of claim 30, wherein the secondary notepad comprises from 5 to 15 sheets of paper.

33. A method of making an organizer device having a card and a clip formed on the card, the method comprising the steps of:
providing paper for at least one card;
cutting the card with a laser die to form a clip having a tongue and a cut shape;
cutting the card from the paper.

34. The method of claim 33, further comprising the steps of:
providing ink for at least one card; and
printing a predetermined pattern on the at least one card.

35. The method of claim 33, further comprising the step of applying an adhesive strip to a back surface of the at least one card.

36. The method of claim 33, further comprising the step of adhering a gripping surface to the tongue of the clip.

37. The method of claim 33, further comprising the step of embossing predetermined text on the card

38. The method of claim 33, further comprising the step of laminating at least one surface of the card.

39. The method of claim 33, further comprising the step of attaching at least one flag to the card.

40. The method of claim 33, wherein the steps of cutting the card with a laser die to form a clip having a tongue and a cut window and cutting the card from the paper each comprise the step of cutting a perforated outline.

41. A method of using an organizer device including a card having a quasi-rectangular ergonomic shape formed from a firm card stock, said card having a substantially linear perforation allowing one section of the card to be removable from a remaining section of the card; and a clip formed on the card and configured to retain at least one sheet of paper, the clip comprising a lower clip portion, an upper clip portion, a tongue portion, a plurality of perforated sections disposed on a central area of the tongue portion, and a gripping surface disposed on a lower edge of the tongue portion; the method comprising the steps of:
inserting at least one sheet of paper into the clip such that the gripping surface of the clip retains the sheet of paper; and
marking status information about the at least one sheet of paper on the card.

42. The method of claim 41, wherein the marking step comprises the step of marking status information on at least one of the perforated sections of the tongue portion.

43. The method of claim 41, wherein the marking step comprises the step of removing at least one of the perforated sections from the central area of the tongue portion.

44. The method of claim 41, wherein the marking step comprises the step of writing information on a writing surface disposed on a front surface of the card.

45. The method of claim 41, wherein the organizer device further comprises a primary notepad and the marking step comprises writing information on a sheet of the primary notepad.

46. The method of claim 45, further comprising the step of removably adhering the sheet of the primary notepad to a selected portion of one of the sheets of paper retained by the clip.

47. The method of claim 41, wherein the organizer device further comprises a first flag rotatably connected to a surface of the card, and the marking step comprises the step of rotating the first flag.

48. The method of claim 41, wherein the organizer device further comprises a first flag rotatably connected to a front surface of the card and a second flag rotatably connected to a rear surface of the card, and the marking step comprises the step of selectively rotating one of the first flag and the second flag.

49. The method of claim 41, wherein the marking step comprises the step of writing status information on the section of the card that is removable along the substantially linear perforation.

50. The method of claim 49, further comprising the step of removing one section of the card from the remaining section of the card along the substantially linear perforation.

51. The method of claim 50, wherein the removable section of the card is configured to be stored in a file, and wherein the method further comprises the step of filing the removable section of the card in a card file.

52. The method of claim 41, wherein the clip is configured to retain a business card and the marking step comprises inserting a business card in the clip such that the clip retains the business card.
